(19) United States
(12) Patent Application Publication
(10) Pub. No.: US 2012/0148261 A1
(43) Pub. Date: Jun. 14, 2012

(54) METHOD AND SYSTEM FOR OPTICAL ORTHOGONAL FREQUENCY DIVISION MULTIPLEXING WITH COMPANDING TRANSFORM

(75) Inventor: Jianjun Yu, Princeton, NJ (US)

(73) Assignees: ZTE Corporation, Shenzhen (CN); ZTE (USA) INC., Richardson, TX (US)

(21) Appl. No.: 13/312,255

(22) Filed: Dec. 6, 2011

Related U.S. Application Data
(60) Provisional application No. 61/422,796, filed on Dec. 14, 2010.

(51) Int. Cl. H04B 10/04; H04B 1/66; H04L 27/28

(52) U.S. Cl. 398/193

(57) ABSTRACT

A companding transform technique is incorporated into orthogonal frequency division multiplexed signals to reduce the peak-to-average ratio of the signals. Prior to the companding transform, an inverse discrete Fourier transform is performed on the signal. Following the companding transform, the signal is compressed, at which point the compressed signal may be advantageously optically transmitted.

### FIELD OF THE INVENTION

The field of the present invention generally pertains to optical communication architecture, particularly to optical communication processes and systems which employ orthogonal frequency division multiplexing.

### BACKGROUND

Orthogonal frequency division multiplexing (OFDM) was first applied to optical communications recently, as described by N. E. Jolley, et al., “Generation and propagation of a 1550 nm 10 Gbit/s optical orthogonal frequency division multiplexed signal over 1000 m of multimode fibre using a directly modulated DFB[C],” in Optical Fiber Communication Conference, 2005. Technical Digest. OFC/NFOEC, 2005, p. 3, Vol. 6. Optical-OFDM (O-OFDM) offers advantages such as high spectral efficiency and elimination of multipath fading and inter-symbol interference (ISI), as well as the ability to combat both chromatic dispersion (CD) and polarization mode dispersion (PMD) in the transmission optical fiber.

O-OFDM has been widely investigated due to these advantages, such as is described by W. Yiyan and W. Y. Zou, “Orthogonal frequency division multiplexing: a multi-carrier modulation scheme[J],” Consumer Electronics, IEEE Transactions on, vol. 41, pp. 392-399, 1995; J. Armstrong, “OFDM for Optical Communications[J],” Lightwave Technology, Journal of, vol. 27, pp. 189-204, 2009; A. J. Lowery, et al., “Orthogonal Frequency Division Multiplexing for Adaptive Dispersion Compensation in Long Haul WDM Systems[C],” in Optical Fiber Communication Conference, 2006 and the 2006 National Fiber Optic Engineers Conference. OFC 2006, 2006, pp. 1-3; and Y. Benlachtar, G. Gavioli, V. Mikhailov, et al., “Experimental investigation of SPM in long-haul direct-detection OFDM systems”, Optics Express, Vol. 16, Issue 20, 2008, pp. 15477-15482.

A major drawback of OFDM signal transmission is that it has a high peak-to-average power ratio (PAPR). According to the central limit theorem, if subcarriers are emphasized at the same direction, there will be a high peak. Therefore, it will lead to high PAPR which requires extending the linearity of high power amplifiers (HPAs) and the dynamic range of Analog-to-Digital Converters (ADCs). However, extending the dynamic range of the components will increase the cost. Moreover, the signal distortion caused by the peaks in the nonlinear area of HPAs will destroy the orthogonality of sub-carriers and degrade signal performance, as is described by Y. Wu and W. Y. Zou, “Orthogonal frequency division multiplexing: A multi-carrier modulation scheme,” IEEE Trans. Consumer Electronics, vol. 41, no. 3, pp. 392-399, August 1995.

Reducing the PAPR of an optical OFDM signal can reduce the nonlinear effects such as self-phase modulation, cross-phase modulation, and four-wave mixing in the transmission fiber. Thus, reduction of PAPR of OFDM signals is an important topic in a O-OFDM transmission system.

Among the methods of decreasing the PAPR of OFDM signals, a simple way is clipping, as is described by D. Kim and G. L. Stuber, “Clipping Noise Mitigation for OFDM by Decision-Aided Reconstruction”, IEEE Communications Letters, Vol. 3, pp 4-6, 1999. However, it causes significant clipping noise, out-of-band radiation, and peak regrowth after digital-to-analog conversion, as has been explained by X. Huang, J. Lu, J. Zheng, et al., “Companding Transform for Reduction in Peak-to-Average Power Ratio of OFDM Signals[J],” IEEE Transactions on Wireless Communications, Vol. 03, No. 6, 2004; J. Armstrong, “Peak-to-average power reduction for OFDM by repeated clipping and frequency domain filtering[J],” Electronics Letters, vol. 38, pp. 246-247, 2002; and K. Dukhyun and G. L. Stuber, “Clipping noise mitigation for OFDM by decision-aided reconstruction[J],” Communications Letters, IEEE, vol. 3, pp. 4-6, 1999.

As an alternative approach, the companding transform (CT) technique has advantages of simple implementation, low computational complexity, and better performance than clipping, as is described by X. Wang, et al., “Reduction of peak-to-average power ratio of OFDM system using a companding technique[J],” Broadcasting, IEEE Transactions on, vol. 45, pp. 303-307, 1999; and X. Wang, et al., “Reply to the comments on ‘Reduction of peak-to-average power ratio of OFDM system using a companding technique’[J],” Broadcasting, IEEE Transactions on, vol. 45, pp. 420-422, 1999.

Many solutions have been presented in the literature on the CT technique in wireless communication. Some solutions are described by X. Wang, et al., “Reduction of peak-to-average power ratio of OFDM system using a companding technique[J],” Broadcasting, IEEE Transactions on, vol. 45, pp. 303-307, 1999; X. Wang, et al., “Reply to the comments on ‘Reduction of peak-to-average power ratio of OFDM system using a companding technique’[J],” Broadcasting, IEEE Transactions on, vol. 45, pp. 420-422, 1999; X. Huang, et al., “Reduction of peak-to-average power ratio of OFDM signals with companding transform[J],” Electronics Letters, vol. 37, pp. 506-507, 2001; X. Huang, et al., “Companding transform for reduction in peak-to-average power ratio of OFDM signals[J],” Wireless Communications, IEEE Transactions on, vol. 3, pp. 2030-2039, 2004; T. Jiang, et al., “Exponential companding technique for PAPR reduction in OFDM systems[J],” Broadcasting, IEEE Transactions on, vol. 51, pp. 244-248, 2005; and J. Hou, et al., “Peak-to-Average Power Ratio Reduction of OFDM Signals With Nonlinear Companding Scheme[J],” Broadcasting, IEEE Transactions on, vol. 56, pp. 258-262, 2010. Specific solutions include: p-law companding based on non-uniform quantization, described by X. Wang, et al., “Reduction of peak-to-average power ratio of OFDM system using a companding technique[J],” Broadcasting, IEEE Transactions on, vol. 45, pp. 303-307, 1999; CT based on calculating equalizing value, described by X. Huang, et al., “Reduction of peak-to-average power ratio of OFDM signals with companding transform[J],” Electronics Letters, vol. 37, pp. 506-507, 2001; exponential companding, described by T. Jiang, et al., “Exponential companding technique for PAPR reduction in OFDM systems[J],” Broadcasting, IEEE Transactions on, vol. 51, pp. 244-248, 2005; a nonlinear companding scheme without a de-companding operation, described by J. Hou, et al., “Peak-to-Average Power Ratio Reduction of OFDM Signals With Nonlinear Companding Scheme[J],” Broadcasting, IEEE Transactions on, vol. 56, pp. 258-262, 2010.

### SUMMARY OF THE INVENTION

The present invention is directed toward optical communication methods and systems which decrease the peak-to-average power ratio of orthogonal frequency division multiplexed signals and increase system capability. In these methods and systems, orthogonal frequency division multiplexing is employed using a companding transform to decrease the peak-to-average power ratio of the resulting optical signals. Initially, an inverse discrete Fourier transform is performed on a signal, to which the companding transform is then applied. Subsequently, the companded signal is compressed, making it ready for transmission as an optical signal.

Additional aspects and advantages of the improvements will appear from the description of the preferred embodiment.

### BRIEF DESCRIPTION OF THE DRAWINGS

Embodiments of the present invention are illustrated by way of the accompanying drawings, in which:

FIG. 1 is a block diagram of an optical DD-OOFDM system with companding transform.

FIG. 2 illustrates a relationship between the PAPR of an OFDM signal and μ.

FIG. 3 illustrates a relationship between the bit-error-ratio (BER) performance and μ after a 120 km transmission.

FIG. 4 illustrates an experimental setup and optical spectra of a DD-OOFDM system.

FIG. 5 illustrates sample complementary cumulative distribution function curves of the PAPR for an OFDM signal.

FIG. 6 illustrates sample BER curves and constellation figures for an OFDM original signal and companded signal.

FIG. 7 illustrates sample BER curves for an OFDM original signal and companded signal at different optical launch powers.

### DETAILED DESCRIPTION OF THE PREFERRED EMBODIMENTS

The method and apparatus disclosed herein incorporate a CT technique in a direct-detection optical orthogonal frequency-division multiplexing (DD-OOFDM) system, without additional hardware or cost, while the PAPR of OFDM signals is reduced and system performance is improved. Specifically, a DD-OOFDM system and scheme is based, in part, on a companding transform, which combines the techniques proposed by X. Wang, et al., “Reduction of peak-to-average power ratio of OFDM system using a companding technique[J],” Broadcasting, IEEE Transactions on, vol. 45, pp. 303-307, 1999 and J. Hou, et al., “Peak-to-Average Power Ratio Reduction of OFDM Signals With Nonlinear Companding Scheme[J],” Broadcasting, IEEE Transactions on, vol. 56, pp. 258-262, 2010 in such a way as to decrease the PAPR of OFDM signals and simultaneously increase system capability. The theoretical analysis and simulation investigation for the companding transform scheme and the relationship between the coefficient μ and the system capability are presented in detail below. Further, system performance at different launch powers has been experimentally demonstrated.

The μ-law companding algorithm which was used in speech processing is proposed to decrease the PAPR of OFDM signals in X. Huang, J. Lu, J. Zheng, et al., “Companding Transform for Reduction in Peak-to-Average Power Ratio of OFDM Signals[J],” IEEE Transactions on Wireless Communications, Vol. 03, No. 6, 2004; J. Armstrong, “Peak-to-average power reduction for OFDM by repeated clipping and frequency domain filtering[J],” Electronics Letters, vol. 38, pp. 246-247, 2002. The CT technique can be viewed as a predistortion procession: At the transmitter, the amplitudes of the small signals are enlarged while the large signals remain the same. As the average power is enhanced through enlarging the small signals, a linear companding is made to make the signals of the equal power. At the receiver, the signal is reverted by expanding.

An OFDM signal at the output of the inverse discrete Fourier transform (IDFT) is

$$s ( n ) = \frac{1}{\sqrt{N}} {\sum }_{k = 0}^{N - 1} S ( k ) {e}^{j 2 π \frac{nk}{N }} ,$$

where n=0, 1 . . . N−1, N is the number of subcarrier, and S(k) is the samples of OFDM signal.

The signal after the CT is

$${s}^{′} ( n ) = C [ s ( n ) ] = \frac{A sgn ( s ( n ) ) ln ( 1 + μ \vert \frac{s ( n )}{A} \vert )}{ln ( 1 + μ )} ,$$

where μ is the companding coefficient and A is the largest amplitude of the signal.

As

$${s}^{′} ( n ) \approx s ( n ) \frac{μ}{ln ( 1 + μ )} ,$$

the OFDM signal is essentially amplified by the factor

$$\frac{μ}{ln ( 1 + μ )} .$$

Therefore, the companded signal s′(n) keeps the power of the signal by multiplying a constant coefficient of

$$K = \frac{ln ( 1 + μ )}{μ} .$$

The compression formula at the transmitter end is

$${s}^{″} ( n ) = \frac{A sgn ( s ( n ) ) ln ( 1 + μ \vert \frac{s ( n )}{A} \vert )}{μ} .$$

At the receiver, the expanded signal is

$${r}^{′} ( n ) = C [ r ( n ) ] = sgn ( r ( n ) ) {A}^{′} [ exp ( \vert r ( n ) \vert \frac{ln ( 1 + μ )}{{A}^{′}} ) - 1 ] / ln ( 1 + μ ) .$$

According to T. Jiang, et al., “Exponential companding technique for PAPR reduction in OFDM systems[J],” Broadcasting, IEEE Transactions on, vol. 51, pp. 244-248, 2005, as the expanding noise is big, the noise of the system with and without the expanding at the receiver is Wₙ/α and Wₙ+bₙ, respectively. Wₙ is channel noise, bₙ is companding noise, and α is attenuation factor which depends on the nonlinearity. As bₙ is small, the system without expanding at the receiver has a better bit-error-ratio (BER) performance. This nonlinear scheme may be incorporated into the systems and methods disclosed. Thus, p-law companding is used at the transmitter, but no de-companding is used at the receiver.

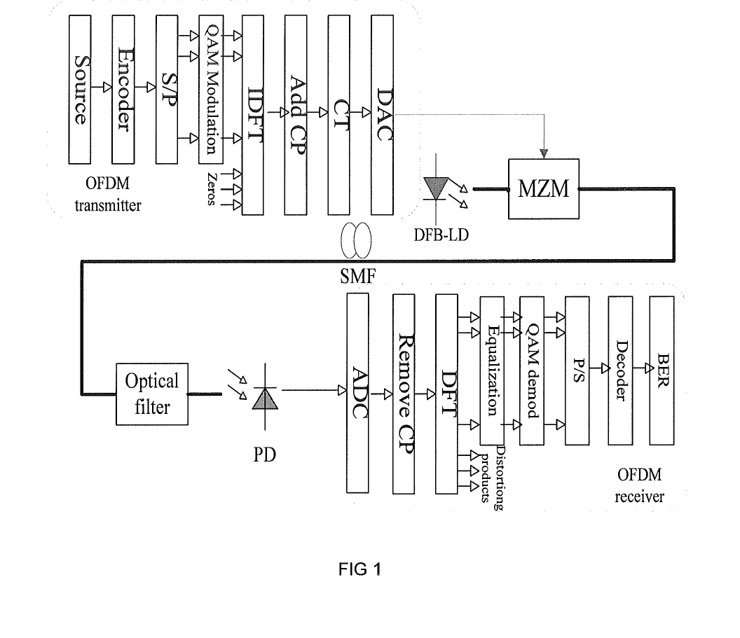

FIG. 1 is a block diagram of an optical DD-OOFDM system based on companding transform. In FIG. 1, MZM: Mach-Zehnder modulator, DFB-LD: distributed feedback laser diode, BER: bit-error-ratio, ADC: analog/digital conversion, DAC: digital/analog conversion, SMF: single mode fiber, PD: photo-diode, S/P: serial/parallel, and P/S: parallel/serial, are shown.

FIG. 1 shows a general DD-OOFDM system based on a CT technique. The CT is employed before DAC at the OFDM transmitter, and there is no de-companding at the OFDM receiver. The O-OFDM signal generation was numerically simulated with commercial software. A continuous lightwave was modulated by a MZM driven by quadrature phase shift keying (QPSK)-OFDM signals with 3 dB bandwidth of 4.8 GHz.

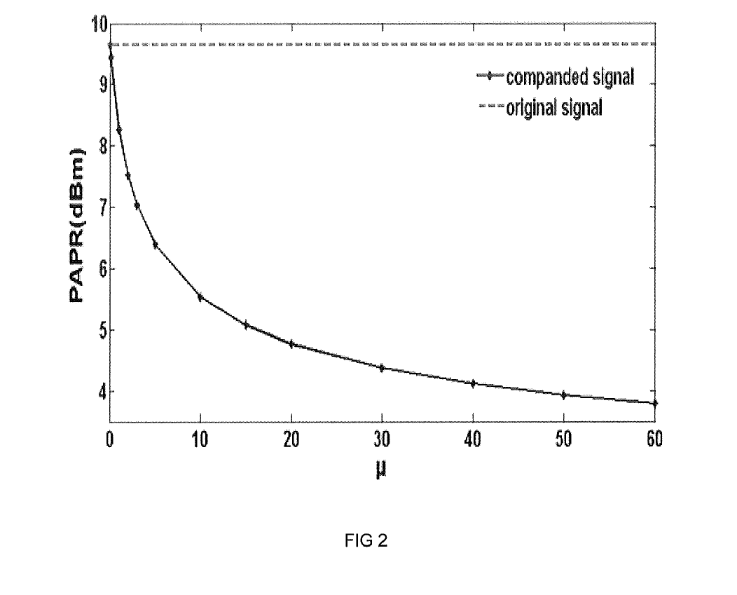

FIG. 2 illustrates the relationship between the PAPR of an OFDM signal and p. FIG. 2 shows that a CT technique can reduce the PAPR of the OFDM signal. Notably, the PAPR of the OFDM signal decreases with the increasing of μ and the increase of the PAPR slows down when μ reaches 6.

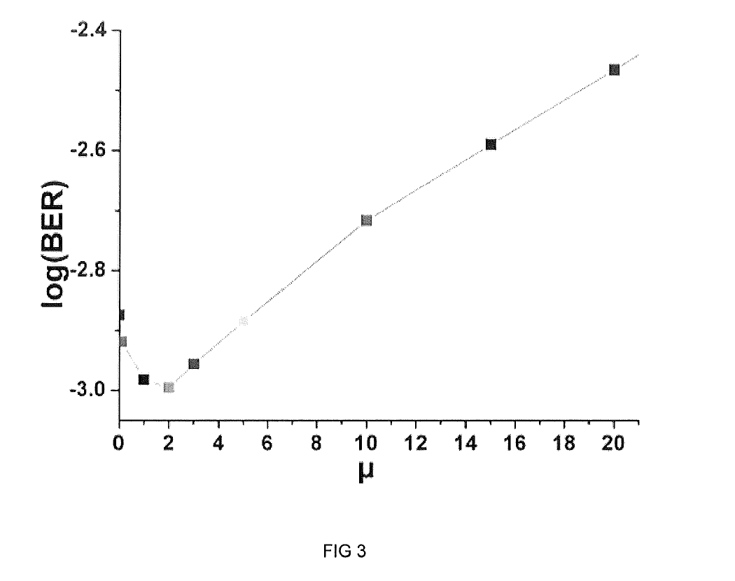

FIG. 3 illustrates the relationship between the BER performance of the system and μ after 120 km transmission. The BER performance is optimal when μ is 2. And the BER performance of the system is better than that of the original system while μ is less than 5. Therefore, choosing an optimal μ can balance the tradeoff between BER performance and PAPR reduction.

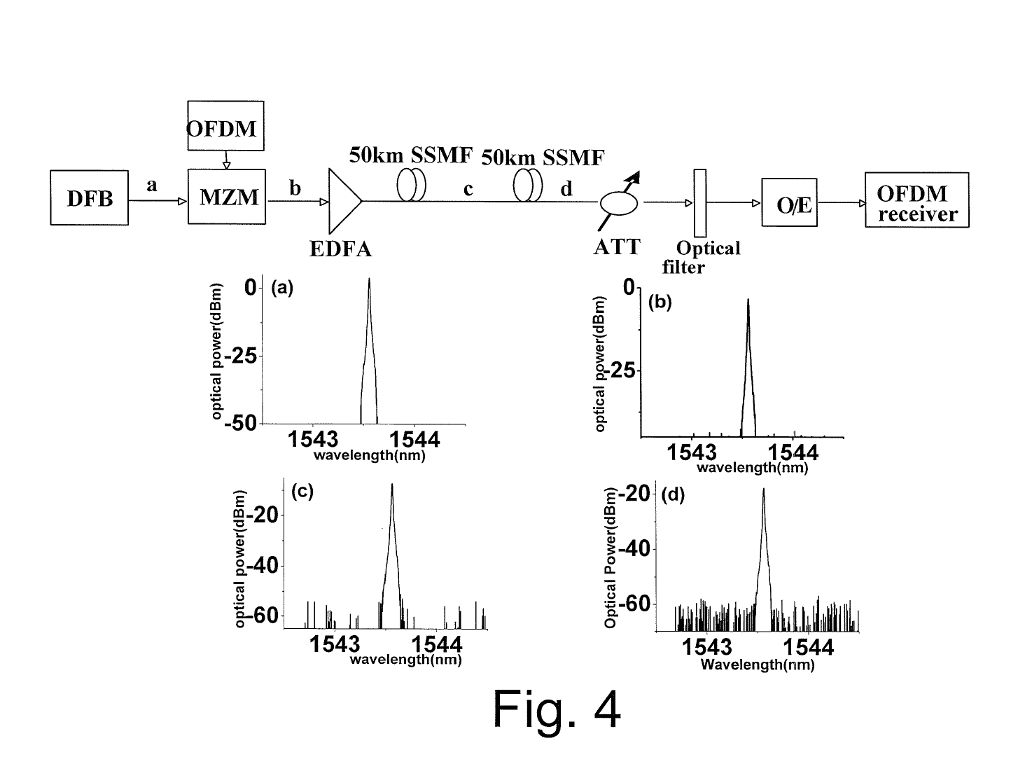

FIG. 4 shows an experimental setup in which a continuous-wave generated by a DFB-LD at 1543.52 nm is fed into a MZM driven by 2.5 Gbit/s OFDM signals generated by using a commercial Arbitrary Waveform Generator (AWG). The half-wave voltage of the MZM is 7V. The driving amplitude (Vp-p) of the OFDM signals is 2V and the output power of the DFB-LD is 7 dBm.

The OFDM baseband signal using QPSK format was generated offline with a MATLAB program. The number of subcarriers is 256, with 192 subcarriers for data, 8 subcarriers used as a Pilot inserted between subcarriers, and the remaining 56 subcarriers were set to 0 as the guard interval (GI).

The modulated optical signal is amplified by a tunable Erbium Doped Fiber Amplifier (EDFA) and transmitted over a 100-km standard single-mode optical fiber (SSMF). An optical filter is used to remove out-of-band noises.

At the optical receiver, the optical OFDM signal is detected and converted by a photo-diode (PD) for optical-electrical conversion. The converted electrical signal was captured by a commercial real-time oscilloscope before being resampled at 10 GSample/s and processed off-line by a Matlab program as an OFDM receiver.

The experiment confirmed the influence of introducing a companding transform scheme into a DD-OOFDM system when μ is 2.

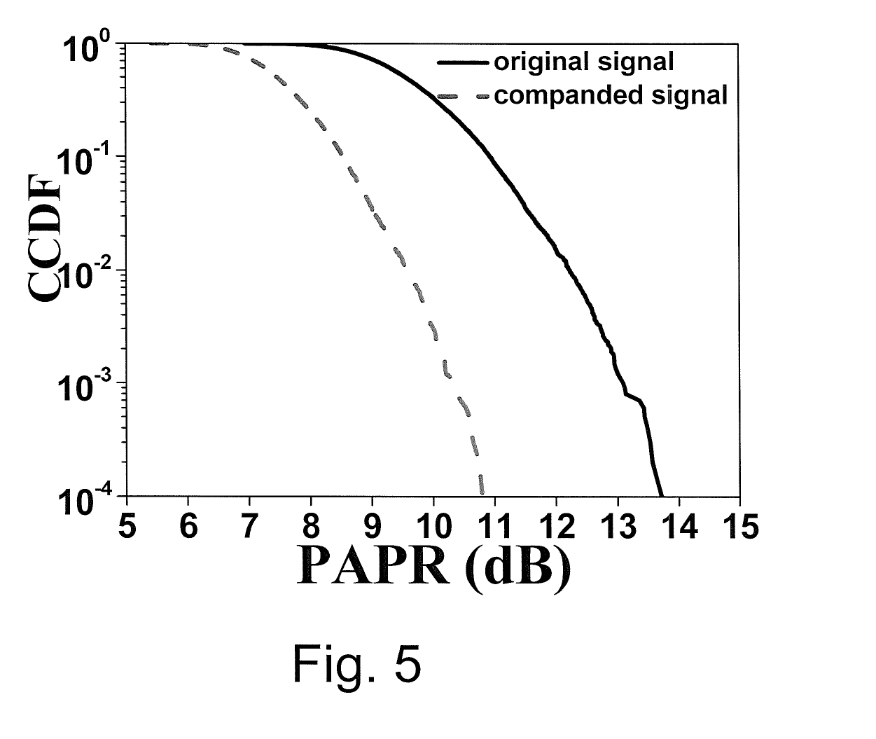

FIG. 5 shows complementary cumulative distribution function (CCDF) curves of the PAPR for OFDM signals. The PAPR of an OFDM signal can be decreased by 3 dB when the CCDF is 10-4, for example.

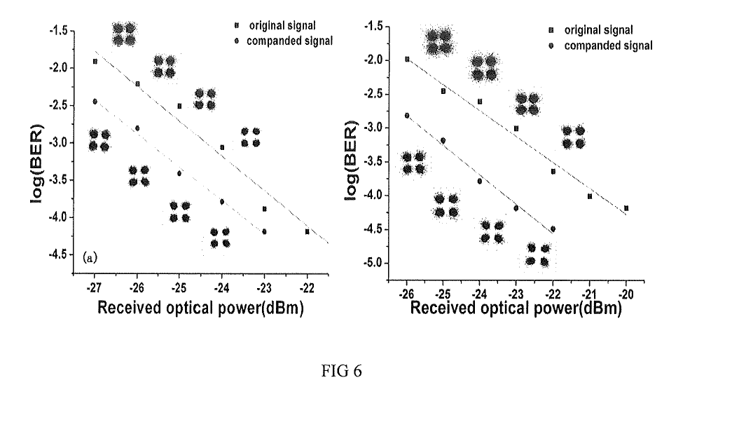

FIG. 6 shows BER curves and constellation figures for an OFDM original signal and companded signal when the fiber launch power is 10 dBm. The BER decreases and the constellation becomes more focused with the increase of received optical power and the constellation of the companded signal is more focused than that of the original signal. Compared with the original system, the receiver sensitivity of the companded signal can be increased by 1 and 2.6 dB at the BER of 10-4 for back-to-back (BTB) and 100-km SSMF transmission, respectively. Therefore, the proposed scheme can offer a better BER performance.

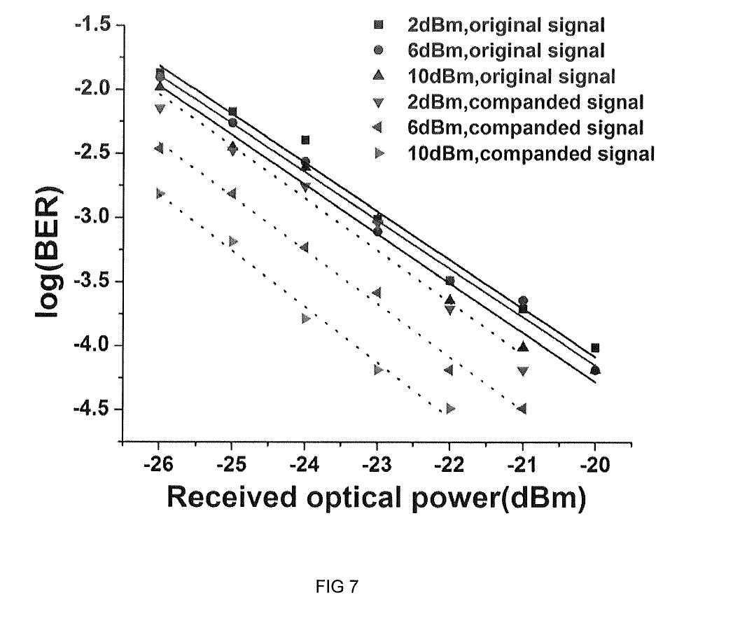

FIG. 7 depicts a comparison of BER performances for an OFDM original signal and the companded signal at different optical launch powers. When the optical launch power is 2, 6, and 10 dBm, the received sensitivity of the companded signal can be increased by 0.8, 1.8, and 2.6 dB at the BER of 10-4, respectively, for example.

For low launch powers, there are small nonlinear effects in the transmission fiber, and the performance of the system is mainly affected by the linearity of HPAs and other optical or electrical components. However, nonlinear distortion effects in the optical fiber may get severe when the optical launch power rises, and it will become an important factor influencing system performance.

As shown in FIG. 7, the increase of received sensitivity significantly increases for higher powers. Therefore, reducing the PAPR of optical OFDM signals can not only minimize the nonlinear distortion effects of HPAs and ADCs, but also significantly reduce the effect of fiber nonlinearity.

Thus, a scheme, method, and system are disclosed and experimentally demonstrated for a DD-OOFDM system based on companding transform without a de-companding operation that can decrease the PAPR of OFDM signals and improve receiver sensitivity. Analysis and simulation results show that the PAPR of the OFDM signal will decrease and the BER of the system firstly decreases and then increases when μ increases; so there is an optimal μ for the O-OFDM transmission signal. Experimental results show that the reduction of the PAPR is about 3 dB when μ is 2, and the received sensitivity is improved by 0.8 dB, 1.8 dB, and 2.6 dB for launch power of 2 dBm, 6 dBm, and 10 dBm, respectively, at a BER of 1×10⁻⁴ after transmission over 100-km SSMF.

While embodiments of this invention have been shown and described, it will be apparent to those skilled in the art that many more modifications are possible without departing from the inventive concepts herein. As one example, the signal processing described herein may be implemented in software or in hardware. The invention, therefore, is not to be restricted except in the spirit of the following claims.

What is claimed:

1. A method of decreasing the peak-to-average power ratio of orthogonal frequency division multiplexed signals and increasing system capability, the method comprising:
performing an inverse discrete Fourier transform on a signal to generate an output signal;
companding the output signal to generate a companded signal;
compressing the companded signal to generate a compressed signal; and
optically transmitting the compressed signal.

2. The method of claim 1, wherein the output signal is characterized by
$$s ( n ) = \frac{1}{\sqrt{N}} {\sum }_{k = 0}^{N - 1} S ( k ) {e}^{j 2 π \frac{nk}{N}} ,$$
where n=0, 1 . . . N−1, N is a subcarrier number, and S(k) is a plurality of samples of the signal.

3. The method of claim 2, wherein the output signal has a largest amplitude and the companded output signal is characterized by
$${s}^{′} ( n ) = C [ s ( n ) ] = \frac{A sgn ( s ( n ) ) ln ( 1 + μ \vert \frac{s ( n )}{A} \vert )}{ln ( 1 + μ )} ,$$
where μ is a companding coefficient and A is the largest amplitude of the output signal.

4. The method of claim 3, wherein 2≦μ<5.

5. The method of claim 2, wherein the companded signal is characterized by
$${s}^{′} ( n ) \approx s ( n ) \frac{μ}{ln ( 1 + μ )} ,$$
where μ is a companding coefficient.

6. The method of claim 2, wherein the output signal has a largest amplitude and the compressed signal is characterized by
$${s}^{″} ( n ) = \frac{A sgn ( s ( n ) ) ln ( 1 + μ \vert \frac{s ( n )}{A} \vert )}{μ} ,$$
where μ is a companding coefficient and A is the largest amplitude of the output signal.

7. A system of decreasing the peak-to-average power ratio of orthogonal frequency division multiplexed signals and increasing system capability, the system comprising:
means for performing an inverse discrete Fourier transform on a signal to generate an output signal;
means for companding the output signal to generate a companded signal;
means for compressing the companded signal to generate a compressed signal; and
means for optically transmitting the compressed signal.

8. The system of claim 7, wherein the means for optically transmitting the compressed signal further comprises an erbium doped fiber amplifier.

9. The system of claim 7, wherein the means for optically transmitting the compressed signal comprises a distributed feedback laser diode and a Mach-Zehnder modulator.

10. The system of claim 7, wherein the output signal is characterized by
$$s ( n ) = \frac{1}{\sqrt{N}} {\sum }_{k = 0}^{N - 1} S ( k ) {e}^{j 2 π \frac{nk}{N }} ,$$
where n=0, 1 . . . N−1, N is a subcarrier number, and S(k) is a plurality of samples of the signal.

11. The system of claim 10, wherein the output signal has a largest amplitude and the companded output signal is characterized by
$${s}^{′} ( n ) = C [ s ( n ) ] = \frac{A sgn ( s ( n ) ) ln ( 1 + μ \vert \frac{s ( n )}{A} \vert )}{ln ( 1 + μ )} ,$$
where μ is a companding coefficient and A is the largest amplitude of the output signal.

12. The system of claim 11, wherein 2≦μ<5.

13. The system of claim 10, wherein the companded signal is characterized by
$${s}^{′} ( n ) \approx s ( n ) \frac{μ}{ln ( 1 + μ )} ,$$
where μ is a companding coefficient.

14. The system of claim 10, wherein the output signal has a largest amplitude and the compressed signal is characterized by
$${s}^{″} ( n ) = \frac{A sgn ( s ( n ) ) ln ( 1 + μ \vert \frac{s ( n )}{A} \vert )}{μ} ,$$
where μ is a companding coefficient and A is the largest amplitude of the output signal.
